(19) United States
(12) Patent Application Publication
(10) Pub. No.: US 2012/0054116 A1
(43) Pub. Date: Mar. 1, 2012

(54) ONLINE DATING SYSTEM INCORPORATING SEARCHING AND AUTOMATIC MATCHING FUNCTIONS

(76) Inventor: NICHOLAS WALLIN, Stamford, CT (US)

(21) Appl. No.: 13/219,253

(22) Filed: Aug. 26, 2011

Related U.S. Application Data
(60) Provisional application No. 61/378,050, filed on Aug. 30, 2010.

(51) Int. Cl. G06Q 99/00

(52) U.S. Cl. 705/319

(57) ABSTRACT

An online dating service where users can manually search for a match using one or more selected criteria or find a plurality of matches automatically using predetermined criteria. The predetermined criteria are derived from information submitted by the user during registration. The predetermined criteria may, in fact, be unknown to the user at the time of registration and may remain unknown to the user throughout the matching process. The illustrated embodiment includes astrological data that is derived from birth information input by users.

### CROSS-REFERENCE TO RELATED APPLICATIONS

This application claims benefits from U.S. Provisional Patent Application No. 61/378,050, filed Aug. 30, 2010, the contents of which are hereby incorporated herein by reference.

### BACKGROUND OF THE INVENTION

1. Field of the Invention

This invention relates broadly to online dating services via the internet. More particularly, this invention relates to systems and methods for matching people automatically based on predetermined criteria and for searching based on selected criteria.

2. State of the Art

One of the fastest growing industries of the twenty-first century is dating services via the internet. Successful services such as eHarmony, Catholic Match, PlentyofFish, and others allow people to interact with friends and potential mates instantaneously via the internet. In addition, these services also permit like minded people to meet through the formation of special interest groups and the publication of user profiles. Other services, such as match.com, provide a generalized traditional dating service via the internet. Specialized dating services such as adgematch.com, catholicmatch.com, dinnermatch.com, malematch.com, millionairematch.com, mycountrymatch.com, queermatch.com, and seniormatch.com all offer the same or similar services as the generic match.com, just targeted to a specific audience.

### SUMMARY OF THE INVENTION

The present invention provides an online dating service where users can manually search for a match using one or more selected criteria or find a plurality of matches automatically using predetermined criteria. The predetermined criteria are derived from information submitted by the user during registration. The predetermined criteria may, in fact, be unknown to the user at the time of registration and may remain unknown to the user throughout the matching process.

According to one embodiment of the invention, a new user logs on and creates an account. The user is then prompted to enter specific requested information. Based on that information, a user profile is created that contains information that was derived from the information input by the user as well as the information input by the user. The derived information (predetermined criteria) is derived using an algorithm. The user profile is stored in a database and is preferably not viewable by the user. The information input by the user is visible and editable by the user. If the derived information is made available to the user for viewing, it is in no case editable by the user. Some or all of the information input by the user will be considered “public information”.

Once the registration process is complete, the user profile database is searched using the derived information (predetermined criteria) to find other users with matching derived information. The derived information from one user matches the derived information of another user, if an algorithmic correspondence is established. The matching is not based on the degree of similarity of the derived information of one user with the derived information of another user. Rather, a match is determined if the derived information of one user satisfies a predetermined algorithmic relationship with the derived information of another user.

After the database is searched, one or more other matching users are identified based on the predetermined criteria (derived information) using the algorithm. An identification of one or more of the matching users is then displayed to the new user. The new user is presented with the opportunity to view the public information of the matching users and, if desired, request communication (e.g. by email or live chat).

According to the illustrated embodiment, the information input by the users includes date of birth information and the derived information includes astrological information which is created using a derivation algorithm. The matching algorithm includes an implementation of known astrological matching techniques. At least some of the derived information and the algorithms (derivation and matching) preferably remain invisible to the users. According to one embodiment of the invention, the users are prompted to enter detailed birth date information, including date of birth, time of birth, place of birth. If only date of birth is input, only sun, and possibly moon, sign(s) are used in the matching algorithm. If time of birth is included, rising sign and placement of all of the planets in the houses can be used in the matching algorithm. If place of birth is included, the algorithm is yet further refined.

The applicant makes no claim to the efficacy of astrological matching other than as an amusement, a self-fulfilling prophesy, or a corollary to the placebo effect. Users who believe that astrological matching will improve their dating success may indeed achieve a higher level of success based on these psychological factors.

In addition to the advanced astrological matching algorithm automatically implemented by the invention, users may execute conventional manual searches based on traditional criteria such as likes and dislikes and geographical location. According to a further advanced embodiment, users may search the “hit list” of automatic matches and filter using the traditional criteria such as likes, dislikes, and geographical location, as well as gender of the matches, religious preference and sexual preference, for example.

Additional objects and advantages of the invention will become apparent to those skilled in the art upon reference to the detailed description taken in conjunction with the provided figures.

### BRIEF DESCRIPTION OF THE DRAWINGS

FIG. 1 is a high level system diagram illustrating a computer network system suitable for implementing the invention;

FIG. 2 is a high level flow chart illustrating a user registration process;

FIG. 3 is a high level flow chart illustrating the algorithm for generating derived information based on user input and generating a user profile for the database;

FIG. 4 is a high level flow chart illustrating the automatic matching algorithm according to the invention;

FIG. 5 is a high level flow chart illustrating the manual matching/filtering according to the invention; and

FIG. 6 is a n example of a natal chart for someone born Jan. 1, 2000, 12:01:00 AM EST, New York City (Longitude: 074W00′23″, Latitude: 040N42′51″).

### DETAILED DESCRIPTION

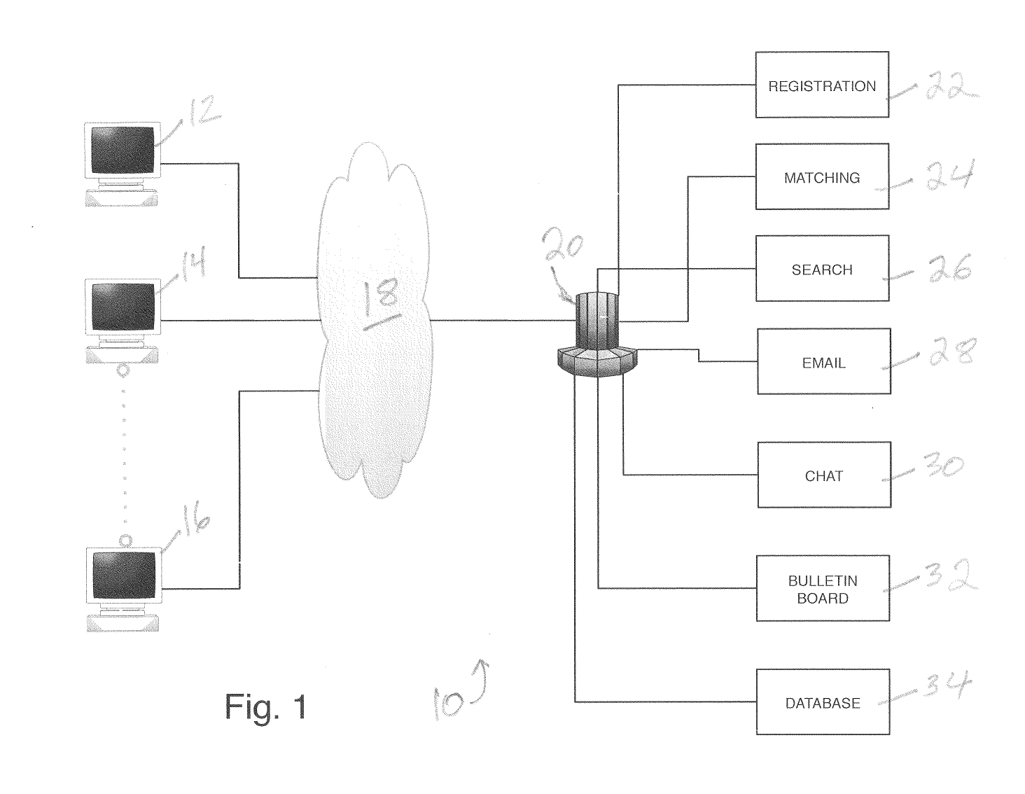

Turning now to FIG. 1, a system 10 for implementing the methods of the invention includes a plurality of remote user terminals (e.g. personal computers, cell phones, tablets, or the like) 12, 14, 16 coupled to a network (e.g. the internet) 18. A server 20 hosting software to implement the methods of the invention is also coupled to the network 18. The remote terminals preferably couple to the server via a URL or IP address.

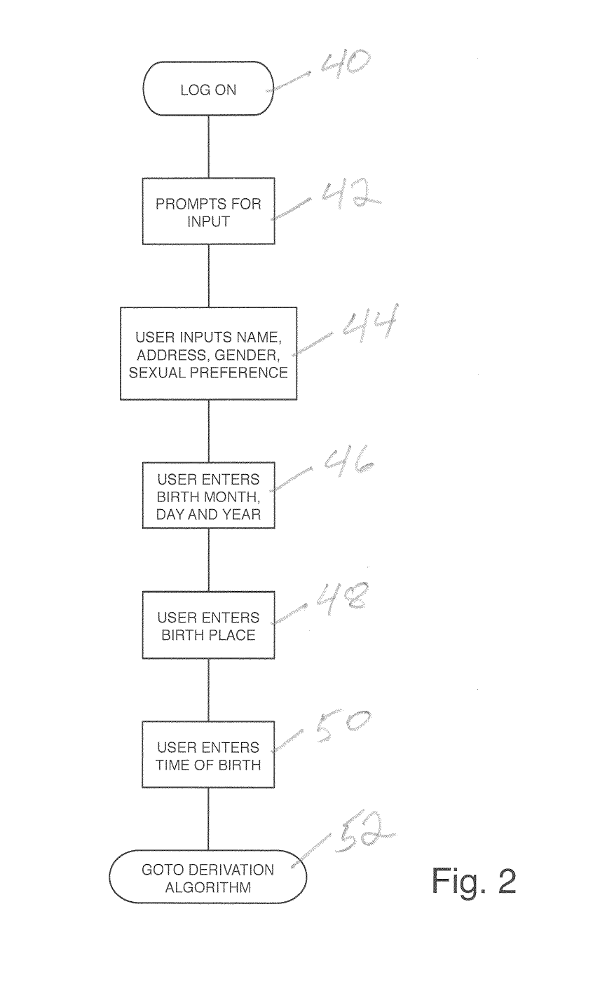

The server 20 preferably runs several software modules, e.g. registration 22, matching 24, search 26, email 28, chat 30, bulletin board 32, and the database 34. Operation of these modules will be further understood with reference to the methods of the invention which are described below with reference to the flow charts of FIGS. 2-5.

FIG. 2 illustrates the registration procedure which may indeed be performed by the registration software module (22, FIG. 1) in conjunction with input by a user from one of the remote terminals (e.g. 12, 14, 16, FIG. 1). The user logs on at 40 and is then presented with prompts for input at 42. These prompts preferably include name, address, email address, physical location address, and birth date information. The prompts preferably also include standard dating service questions, such as likes and dislikes, physical characteristics, religious preferences, sexual preferences, etc. The birth date information prompts preferably include: month, day, year, place of birth, and time of birth. In response to the prompts, the user enters the non-birth date information at 44. The minimal information of birth month, day and year (year can be optional) are entered at 46. Enhanced information of birth place is entered at 48. Place information may be entered through pull down menus or via entry of a zip code (postal code if outside the US). At 50, the user enters the time of birth if known. After the input information is completed, the information is processed at 52 to create a user profile. The derivation module may be incorporated as part of the registration module (22, FIG. 1) or the matching module (24, FIG. 1) or it may be a separate module (not shown).

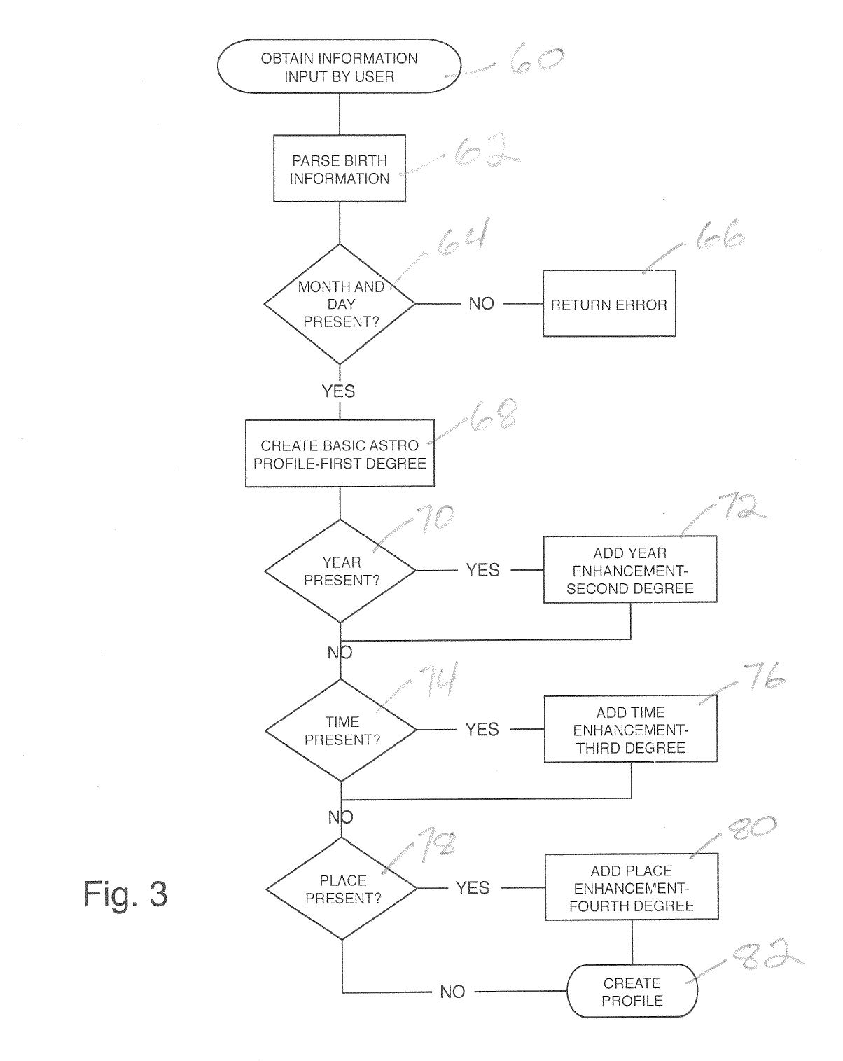

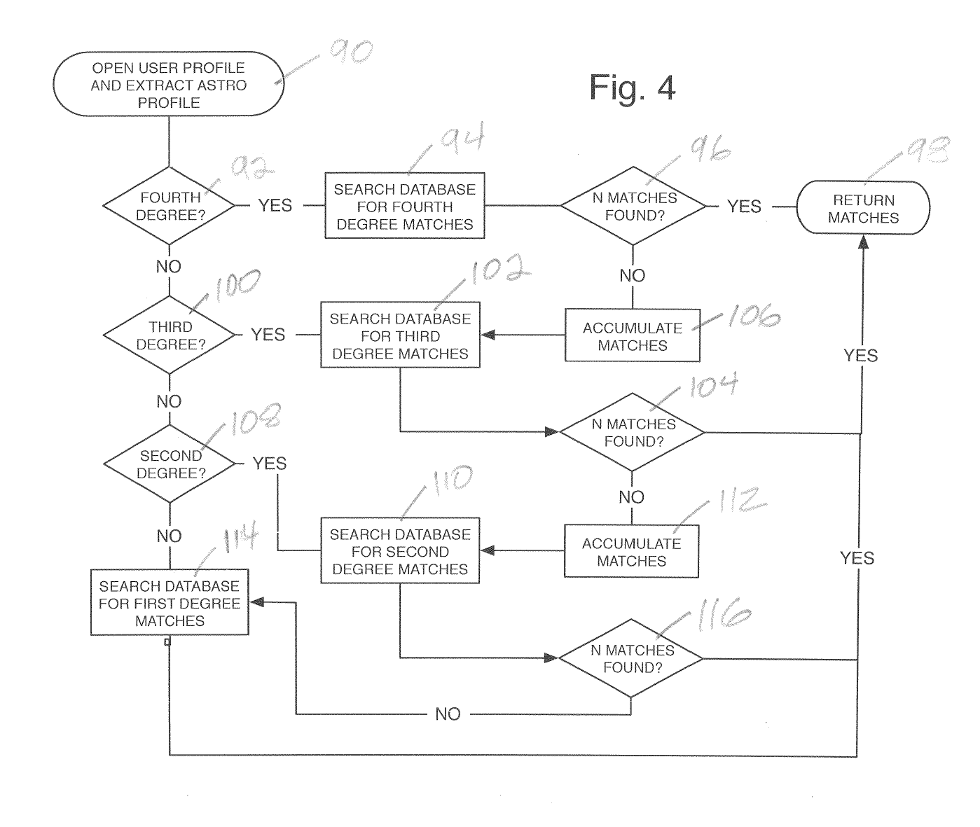

An example of how the derivation algorithm works is illustrated in FIG. 3. The information input by the user is obtained at 60. Birth information is parsed at 62. At 64, it is determined whether the user has input a month and day of birth (the minimum information to assign an astrological sign). If not, an error message is returned at 66 and the user is prompted to input the missing information. Once the month and day of birth are known, a basic astrological profile is created using the information in Tables 1 and 2, below. Table 1 matches an astrological sign to a user based on birth month and day. Table 2 assigns four possible astrological matching signs which will be used for the automatic matching algorithm described in FIG. 4. Typically, the Tropical Zodiac (common in the West) will be used, but according to an optional embodiment, a user may choose to use the Sidereal Zodiac (common among Hindus).

TABLE 1
Sign

| | | | Sidereal zodiac |
|---|---|---|---|
| | | Tropical zodiac | (Jyotisha) |
| Name | Symbol | (2011) | (2011, UTC) |
| Aries | [symbol] | 21 March-20 | 14 April-14 |
| | | April | May |
| Taurus | [symbol] | 21 April-20 | 14 May-14 |
| | | May | June |
| Gemini | [symbol] | 21 May-20 | 14 June-14 |
| | | June | July |
| Cancer | [symbol] | 21 June-21 | 14 July-14 |
| | | July | August |
| Leo | [symbol] | 22 July-22 | 14 August-13 |
| | | August | September |
| Virgo | [symbol] | 23 August-22 | 13 September-14 |
| | | September | October |
| Libra | [symbol] | 23 September-22 | 14 October-13 |
| | | October | November |
| Scorpio | [symbol] | 23 October-21 | 13 November-14 |
| | | November | December |
| Sagittarius | [symbol] | 22 November-21 | 14 December-13 |
| | | December | January |
| Capricorn | [symbol] | 22 December-20 | 13 January-12 |
| | | January | February |
| Aquarius | [symbol] | 21 January-19 | 12 February-14 |
| | | February | March |
| Pisces | [symbol] | 20 February-20 | 14 March-14 |
| | | March | April |

TABLE 2

| | | |
|---|---|---|
| | | NEAR PERFECT |
| SIGN | PERFECT MATCH | MATCH |

| | | | | |
|---|---|---|---|---|
| Aries | Leo | Sagittarius | Gemini | Aquarius |
| Taurus | Virgo | Capricorn | Cancer | Pisces |
| Gemini | Libra | Aquarius | Aries | Leo |
| Cancer | Scorpio | Pisces | Taurus | Virgo |
| Leo | Aries | Sagittarius | Gemini | Libra |
| Virgo | Taurus | Capricorn | Cancer | Scorpio |
| Libra | Gemini | Aquarius | Leo | Sagittarius |
| Scorpio | Cancer | Pisces | Virgo | Capricorn |
| Sagittarius | Aries | Leo | Libra | Aquarius |
| Capricorn | Taurus | Virgo | Scorpio | Pisces |
| Aquarius | Gemini | Libra | Aries | Sagittarius |
| Pisces | Cancer | Scorpio | Taurus | Capricorn |

An enhanced astrological profile is created if additional information about birth is input. If the year of birth is present as determined at 70, a second degree-enhancement is added at 72. If the time of birth is present as determined at 74, a third degree enhancement is added at 76. If the place of birth is present as determined at 78, a fourth degree enhancement is added at 80. The final astrological profile is created at 82.

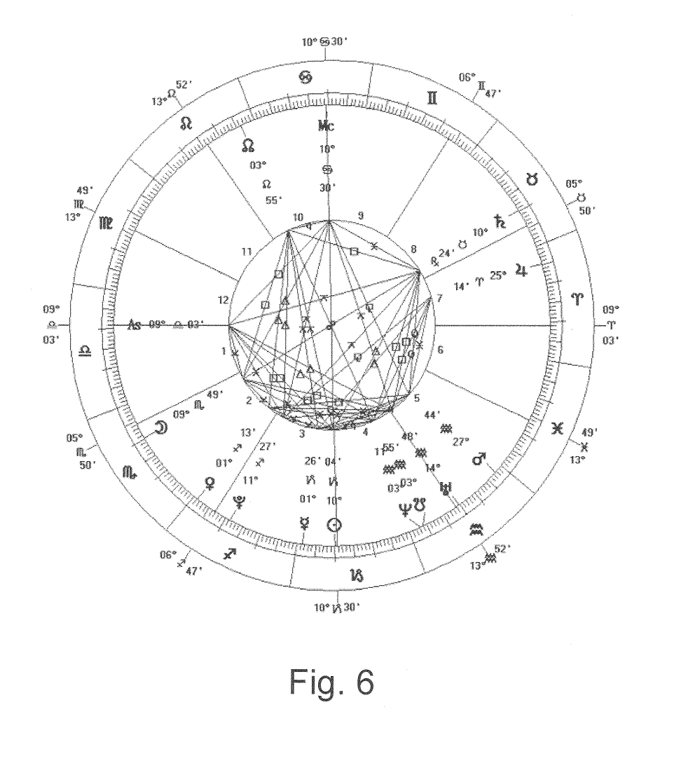

As mentioned above, if only month and day are input, the first degree profile is created using the matching algorithms derived from Tables 1 and 2. If additional second, third, or fourth degree information is provided, a natal chart such as the one pictured in FIG. 6 can be generated. While FIG. 6 is a graphical presentation of natal information which includes month, day, year, time, and place of birth, a similar chart can be constructed with as little information as month, day and year. In addition, while FIG. 6 illustrates the information in graphical form, the information can be represented in tabular form for manipulation by an automated algorithm. See, e.g. Ronald Davison. (1983). “Synastry: Understanding Human Relations Through Astrology”. Publisher: Aurora Press, Inc. ISBN 0943358051; E. W. Neville. (1997). “Planets in Synastry: Astrological Patterns of Relationships”. Publisher: Whitford Press, Inc. ISBN 0924608013; Christine Rakela. (2004). “Love Relationship Formula: Predicting Romantic Success with Astrology “. Publisher: Llewellyn Publications, Inc. ISBN 0738704245; and Nance McCullough (2002), “Love Formulas-2”, Publisher: Namac Pub, ISBN 0936916044. The disclosures of these documents is hereby incorporated herein by reference. [IT WOULD BE ADVISABLE FOR US TO GET COPIES OF THESE BOOKS AND SUBMIT THEM TO THE PTO. I THINK THEY ARE ALL AVAILABLE ON AMAZON.]

FIG. 4 illustrates an example of how the automatic matching algorithm is implemented according to the invention. The user profile is opened at 90 and the astrological profile is extracted for matching to the complete database of users (34, FIG. 1). The algorithm then checks the completeness of the astrological profile in order to provide the most accurate matches. For example, if it is determined at 92 that the profile includes fourth degree information (i.e. all four degrees of natal information: month+day, year, time, and place) the database is searched at 94 for other users who have entered all four degrees of natal information. A threshold “n” number of matches is set (e.g. four matches since that is the maximum obtainable with only first degree (month and day) natal information. Alternatively, for degrees higher than first, a higher n value may be set. If the four degree matching at 94 produces n number of matches as determined at 96, the match results are returned to the user at 98. The match results are preferably anonymous and include only age, gender, zip code, public information, and an anonymous email hotlink, for example.

If it is determined at 96 that fewer than n number of matches are found, the found matches are accumulated at 106 and a third degree search is performed at 102. The same search is performed at 102 if it is determined that only three degrees of natal information are available. This search is also performed as a result of the decision at 100 that the auto match user profile only has three degrees of natal information. After performing the third degree search at 102, it is determined at 104 whether there are now n number of matches found. If there are, the results are returned at 98 as described above.

If it is determined at 104 that fewer than n number of matches have been found thus far, the found matches are accumulated at 112 and a search for second degree matches is performed at 110. This search is also performed if it is determined at 108 that the auto match user profile only has two degrees of natal information. After performing the second degree match at 110, it is determined at 116 whether there are now n number of matches found. If there are, the results are returned at 98 as described above.

If it is determined at 116 that fewer than n number of matches have bee found thus far a first degree search is performed at 114 using Table 2 and the results returned at 98. This search is also performed if it is determined at 108 that only first degree information is available for this user.

When the results are obtained at 98, the user can click on the anonymous email hotlink for one or more matches and request an exchange of more detailed information and optionally provide more detailed information including a photograph if desired. Alternatively, the user can filter the match results using conventional match criteria such as likes and dislikes, geographical location, religious preferences, sexual preferences, etc. These match criteria can also be applied to the entire database bypassing the automatic astrological matching so that the system operates like a conventional match system.

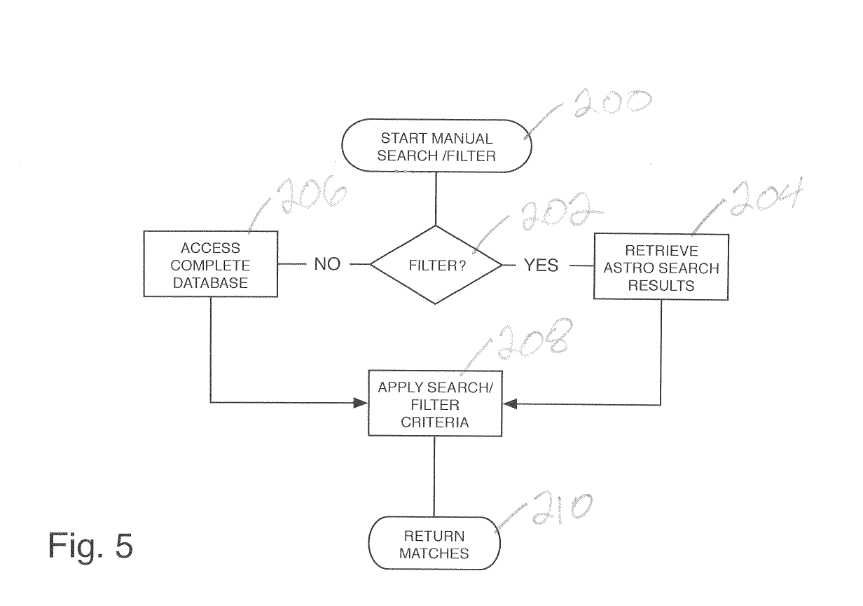

FIG. 5 illustrates how a user can filter the automatic match results or bypass the automatic results and perform a conventional match search. The user initiates the process at 200 and chooses at 202 whether the search will be a filtering of the automatically found results 204 or a fresh conventional search of the complete user database 206. In either case, the user can choose which conventional criteria to apply at 208. For example, if filtering automatically found results, the user may choose to filter only by postal code or sexual preference or religious preference or some combination of criteria. Similarly, when searching the complete database without regard to astrological profiles, the user may select one or more conventional criteria from their own profile to search the profiles of other users. The results are returned at 210.

There have been described and illustrated herein several embodiments of a system and methods for online dating which incorporates both automatic and manual matching functions. While particular embodiments of the invention have been described, it is not intended that the invention be limited thereto, as it is intended that the invention be as broad in scope as the art will allow and that the specification be read likewise. It will therefore be appreciated by those skilled in the art that yet other modifications could be made to the provided invention without deviating from its spirit and scope as claimed.

What is claimed is:

1. A method for providing an online dating service, the method being implemented on one or more servers coupled to a computer network and two or more remote user computers coupled to the network, said method comprising:
collecting provided information from each of a plurality of users at the remote user computers;
creating derived information for each of said plurality of users based on the provided information using an algorithm at the one or more servers;
storing in a database at the one or more servers a user profile for each of the plurality of users, said user profiles each containing said derived information;
matching user profiles using an algorithm at the one or more servers to match derived information; and
providing match information to a user at the remote user computer.

2. The method according to claim 1, wherein:
the provided information includes date of birth information; and
the derived information includes astrological information.

3. The method according to claim 2, wherein:
the provided information includes address information.

4. The method according to claim 3, wherein:
the provided information includes an indication of the gender of the user.

5. The method according to claim 4, wherein:
the provided information includes an indication of the sexual preference of the user.

6. The method according to claim 2, wherein:
the date of birth information includes month, day, and year.

7. The method according to claim 6, wherein:
the date of birth information includes an indication of place of birth.

8. The method according to claim 7, wherein:
the date of birth information includes an indication of time of birth.

9. The method according to claim 2, wherein:
the astrological information is based on the Tropical Zodiac.

10. The method according to claim 2, wherein:
the astrological information is based on the Sidereal Zodiac.

11. A system for providing an online dating service, the system being implemented on one or more servers coupled to a computer network and two or more remote user computers coupled to the network, said system comprising:
means for collecting provided information from each of a plurality of users at the remote user computers;
means for creating derived information for each of said plurality of users based on the provided information using an algorithm at the one or more servers;
means for storing in a database at the one or more servers a user profile for each of the plurality of users, said user profiles each containing said derived information;
means for matching user profiles using an algorithm at the one or more servers to match derived information; and
means for providing match information to a user at the remote user computer.

12. The system according to claim 11, wherein:
the provided information includes date of birth information; and
the derived information includes astrological information.

13. The system according to claim 12, wherein:
the provided information includes address information.

14. The system according to claim 13, wherein:
the provided information includes an indication of the gender of the user.

15. The system according to claim 14, wherein:
the provided information includes an indication of the sexual preference of the user.

16. The system according to claim 12, wherein:
the date of birth information includes month, day, and year.

17. The system according to claim 16, wherein:
the date of birth information includes an indication of place of birth.

18. The system according to claim 17, wherein:
the date of birth information includes an indication of time of birth.

19. The system according to claim 12, wherein:
the astrological information is based on the Tropical Zodiac.

20. The system according to claim 12, wherein:
the astrological information is based on the Sidereal Zodiac.
